(19) United States
(12) Patent Application Publication
(10) Pub. No.: US 2012/0298893 A1
(43) Pub. Date: Nov. 29, 2012

(54) PRESSURE CONTROL VALVE WITH APERTURE

(75) Inventors: Georg Scherer, Kirchheim (DE); Helmut Mang, Memmingen (DE); Florian Schreiber, Kadeltshofen (DE)

(73) Assignee: FIRMA SVM SCHULTZ VERWALTUNGS-GMBH & CO. KG, MEMMINGEN (DE)

(21) Appl. No.: 13/479,964

(22) Filed: May 24, 2012

(30) Foreign Application Priority Data
May 27, 2011 (DE) 10 2001 103 844.6

(51) Int. Cl. F16K 31/12

(52) U.S. Cl. 251/30.01

(57) ABSTRACT

The invention refers to an electro-magnetic pressure control valve with a magnetic part and a valve part. The magnetic part has at least on coil that can be electrically triggered, a coil core and an armature guided traversingly. The valve part has a feed for the pressurized medium, a return and a consumer connection. The valve part has at least two seat valves that can be closed each by a valve element.

### BACKGROUND OF THE INVENTION

The invention refers to an electro-magnetic pressure control valve with a magnetic part of at least one coil that can be electrically triggered, a coil core and an armature that is guided traversing and a valve part having a feed for the pressurized medium, a return and a consumer connection. The valve part has here at least two seat valves that each can be sealed by a valve element. The seat valves or the valve elements are in operative connection with the armature. At the seat valve first seen in direction of medium flow a loose valve element is provided.

Electro-magnetic pressure control valves of this type are known, for example, from the European patent application EP 1 004 066.

Control pressure valves of this type are employed, for example, in automatic transmissions in vehicles. These pressure control valves are constructed such that in direction of the medium flow in the feed a first seat valve is arranged separating the consumer connection from the feed. The return can be connected to the feed via a second seat valve. The pressurized medium is in connection with the feed; the arrangement is chosen such that the valve element is pushed on the seal seat of the seat valve by the medium flow. To control the pressure, the armature of an electro-magnetic magnetic part of the electro-magnetic pressure control valve acts on the valve element via an activation rod. The magnetic part has to generate a magnetic power that is larger than the surface pressure in connection with the seal seat.

On the one hand, the cross section surface of the seat valve should be as small as possible to keep the resulting opening forces generated by the magnetic part low. Thus, the energy required for opening the pressure control valve remains also low. On the other hand, a sufficient volume flow of the medium to be controlled has to be provided, what restricts the surface of the seat valve accordingly.

The arrangement is chosen such that the pressurized medium pushes the valve element on the seal seat of the seat valve, and on the backside an activation rod engages at the valve element on the side opposite the pressure and lifts it from the seal seat when the armature is operated. The effective volume flow is therefore also reduced by the cross section surface of the activation rod (in the area of the valve element).

### SHORT ABSTRACT OF THE INVENTION

It is an object of the present invention to improve the state of the art such that, when the magnetic part is equipped identically, a larger volume flow can be controlled with the pressure control valves of this type.

In order to solve this problem the invention refers to an electro-magnetic pressure control valve as described in the beginning, and suggests that the valve element of the first seat valve is adjustable by an activation rod against the pressure of the medium, and the activation rod is configured pin-like and is set in a control rod that is in operative connection with the armature.

The suggestion according to the invention surprisingly presents the option of employing activation rods with a clearly smaller cross section than the suggestions according to the state of the art. The problem that existed here was that a metal-cutting machining of the often very filigree activation rods is only possible to a certain limit of the components, that means to a certain diameter, as the generally unavoidable machining forces can easily bend the components usually having a diameter less than 1 mm during machining, and thus they are rendered unusable. A configuration of the activation rod along with the control rod in one piece may therefore require a large effort, so that it is much more convenient, even if an additional machining step is required, to insert a separate activation rod in the control rod at its end facing the valve element of the first seat valve.

Surprisingly, however, the two-piece design offers also other, additional options. Thus, it is possible that the activation rod is formed of another material than the control rod, and, because of this configuration, the activation rod can have additional properties, what would be very complex and expensive or impossible to realize in a one-piece control-activation rod. Thus, it is provided, for example, that only the activation rod is hardened to counteract a premature brushing of the front end of the activation rod acting permanently on the valve element. If this brushing is avoided reliably, an appropriate extension of the endurance of the electro-magnetically operated control pressure valve according to the invention is accomplished immediately. This additional component may be more complicated to manufacture and to mount than a one-piece embodiment, however, the suggestion according to the invention surprisingly offers enormous advantages: on the one hand, the flexibility of adapting the electro-magnetic control pressure valve according to the invention to different ranges of application, but also, on the other hand, a considerable improvement of the control pressure valve according to the invention itself leading to an increase of endurance.

Cleverly, here the pin-like activation rod is produced in a preferred, perfect process in a pin-like configuration, where a sufficient straightness is guaranteed.

Therefore, the invention suggests in another improvement that in the seat valve first seen in direction of medium flow, the diameter of the activation rod is less than 0.49 mm, in particular less than 0.45 mm, preferably less than 0.40 mm, or has in particular a diameter of less than 0.3 mm, preferably less than 0.25 mm. The arrangement according to the invention allows manufacturing these filigree, pin-like activation rods with high accuracy and straightness independently from the control rod, and thus realizing even very small diameters that allow a higher medium flow, when the diameter of the aperture or the surface of the seal seat remains unchanged, and when the operational parameters are unchanged.

It has to be noted at this point that the problem according to the invention is also solved by an electro-magnetic pressure control valve, that is configured with a magnetic part of at least one electrically triggered coil, a coil core and a traversably guided armature as well as a valve part, wherein the valve part has at least one feed for the pressurized medium, at least one return and at least one consumer connection, wherein the valve part has at least two seat valves each of it can be closed by a valve element, with one seal seat each, wherein the valve elements are in operative connection with the armature (these characteristics thus define a one-piece construction of the control activation rod), and at the seat valve first seen in direction of the medium flow the diameter of the activation rod is less than 0.49 mm, in particular less than 0.45 mm, preferably less than 0.40 mm, in particular has a diameter of less than 0.30 mm, preferably less than 0.25 mm. This means, the problem according to the invention is also solved by a one-piece design of activation rod and control rod, resulting, for example, in a rather complex manufacturing process just of the section of the control rod forming the activation rod. The idea of the invention is therefore in no way restricted to a two-piece design. It is clear that all other characteristics of this application refer accordingly to this idea of the invention.

Alternatively or additionally it is suggested according to the invention that in the seat valve first seen in direction of medium flow, the ratio of surface of the seat valve (the aperture) to the cross section surface of the activation rod is more than 4.5, in particular more than 5, preferably more than 6, in particular preferred more than 7, 8 or even 9.

Thus, the diameter of the activation rod and the cross section surface area of the activation rod, respectively, in the area of the first seat valve, that is the aperture in this area, and in particular the geometric data of the activation rod in the area are crucial here where the activation rod acts on the valve element. By an appropriate reduction of the diameter of the activation rod, the effective cross section of the volume has been enlarged successfully, when the first seat valves have been opened.

In particular, the invention also claims a diameter less+ than 0.48 mm, 0.47 mm, 0.46 mm, as well as also less than 0.44 mm.

The ratio of the surface of the seat valve to the cross section surface of the activation rod is more than 4.5, in particular more than 5; in particular more than 5.5, 6, 6.5, 7 or 8.

The before mentioned characteristic with respect to the surface ratio can be realized here in the two-piece configuration of activation rod and control rod, as well as in the one-piece control-activation rod design, and is also disclosed in the frame of this application.

Another improvement of the invention provides that at the valve first seen in direction of medium flow, the face of the activation rod is less than 1 mm², in particular less than 0.8 mm², preferably less than 0.7 mm². The face of the activation rod is here the visible surface in a lateral view of the activation rod inserted in the control rod. When seen this way, besides the diameter of the activation rod, also its effective length, that is its protrusion beyond the end of the control rod, has to be considered. It is clear that by means of this suggestion even very filigree activation rods can be realized and employed according to the invention.

Referring to this characteristic, it has also to be noted again that this is the case for the two-pieces configuration of activation rod and control rod as well as for the one-piece configuration with a combined control-activation rod, what again goes for the frame of this application.

It is the effect of the suggestion according to the invention that, when the magnetic conditions remain the same, that is when the required opening forces for opening the first seat valve remain the same, the volume flow through the first seat valve and the first aperture, respectively, increases accordingly. Vice versa, this effect can be used for dimensioning the magnetic part slightly weaker in order to control the same volume flow. A smaller dimensioning of the magnetic part leads here eventually to a corresponding saving of energy during operation.

In a preferred embodiment of the suggestion, the activation rod projects in the aperture defining the first seat valve, and the diameter is at least in this area, in which the activation rod projects in the aperture, constant or essentially constant. For example, a calculated average value of the diameter with reference to this area can serve as essentially constant in this area.

Furthermore, it is provided, that the valve element of the first seat valve is configured as loose ball, that is lifted by the activation rod against the medium flow from the seal seat in the opened position of the seat valve. The configuration of the valve element as loose ball has essential advantages when interacting with a circular seal seat. A loose connection of the valve element with the activation rod means that the two elements are not in one piece or there is no rigid connection between these two elements, that means there are also conditions where, for example, the activation rod is moved and no movement of the valve element results thereof.

Furthermore, it is provided that at the first seat valve on the side opposite the seal seat an in particular cone-like widening is provided having in particular an opening angle of 45° to 90°. Usually, the valve part is manufactured as plastic injection part or molded part. It is obvious that it is an advantage with respect to the flow, if, seen in flow direction, an aperture as short as possible or a tapering is arranged in the flow path. However, this is difficult to realize as very thin material walls occur that cannot be reproduced with a high stability. When the cone of the drain is arranged, the material wall forming (also) the aperture is formed stronger, without forming an additional flow resistance. The suggestion combines here a favorable manufacturing process having a low reject with an arrangement that is perfect for the flow.

Cleverly, it is provided here, that between the seal seat (the valve element rests on it, when the valve is closed) and the widening a cylindrical aperture is provided, and the ratio of the height of the aperture to the diameter of the seal seat is less than 0.4, in particular less than 0.3. The cylindrical aperture eventually defines the diameter of the seal seat or the aperture has the same diameter as the seal seat. This recess does not exclude that also on the side facing the valve element the seal seat is formed by a cone ring. However, it is more favorable, as this leads to smaller closing forces, to choose as seal seat of the ring edge the marginal edge of the aperture facing the valve element. In this way it is also shown in the drawing. Thus, the height of the aperture is the height of the cylinder that has, according to its definition, a constant diameter along its height. When the height is as low as possible (in the flow direction of the pressurized medium), flow resistances are reduced.

Advantageously, the pressure control valve is configured as proportional pressure control valve, wherein, for example, a proportional solenoid is employed as solenoid. A proportional solenoid is characterized in that the position of the armature is in wide areas proportional to the impressed current.

The suggestion of the invention where an activation rod is provided, manufactured separately from the control rod and to be connected therewith, has the advantage that this can be manufactured, for example, of hardened material and thus contributes a considerable share to increasing the endurance of the valves according to the invention. The activation rod, in particular the activation rod facing the valve element, is formed of hardened material, and has preferably a (tensile) strength of more than 800 N/mm², in particular more than 900 N/mm². Here, for example, (tensile) strengths in the area between 1000 N/mm² and 1300 N/mm², preferably about 1200 N/mm² +/−5% are used.

In particular for metallic materials, hardening is a usual means for increasing the endurance or wear resistance. Alternatively, here also ceramic materials can be used, as just here the idea of the invention of the two-piece of activation rod and control rod proofs positive, as different materials can be employed in this area.

Cleverly, here a welding, gluing, soldering or caulking or flanging connection is provided between the activation rod and the control rod. Besides the material connections, also gluing connections as well as mechanic connections can be used, the perfect connection is a result of the materials to be combined and the field of use.

Cleverly, the control rod is equipped at its front side facing the valve element with a bore hole receiving the control rod and in which the control rod is fastened or held. The control rod therefore often has a larger axial length during manufacturing in order to guarantee sufficient projection in the bore hole; the result is here a good mechanic connection or mechanical strength of the activation rod.

A preferred embodiment of the invention provides that the operative connection between the armature and the valve element is formed by a one-piece unit or a unit connected stably of several elements of armature and control rod, or at least as operative connection a power transmission is provided between the otherwise single or loose elements armature and control rod.

The term “operative connection” comprises all arrangements between the electro-magnetically movable armature and the control rod, or eventually the activation rod supported in (or also fitted in one-piece) the control rod that are suited for effecting the movement of the armature to a resulting movement of the activation rod and thus also of the valve element that has to be moved. These comprise rigid connections of single elements as well as loose arrangements that are realized, for example, by appropriate springs or other elements, pre-clamped to each other or in contact.

### BRIEF DESCRIPTION OF THE DIFFERENT VIEWS OF THE DRAWINGS

In the drawing the invention is shown schematically by means of an embodiment. In the figures:

FIG. 1 in a lateral sectional presentation a section of the pressure control valve according to the invention,

FIGS. 2a, 2b in two different positions the detail of the first seat valve according to the invention.

### DETAILED DESCRIPTION OF THE PREFERRED EMBODIMENT

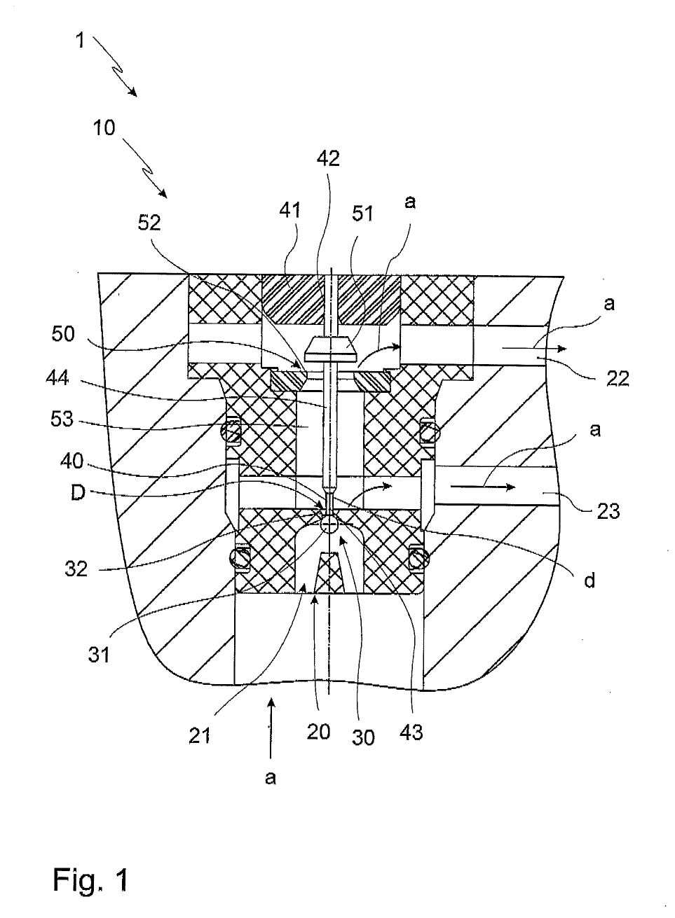

An electro-magnetic pressure control valve according to the invention is shown in FIG. 1 in a lateral sectional representation. The pressure control valve 1 consists here of a magnetic part 10 arranged in the drawing in the upper area. The magnetic part 10 comprises at least one electrically triggered coil, a coil core and a traversingly guided armature; the traversingly guided armature acts on the activation rod 40 penetrating the magnetic core 41 in a penetration bore hole 42.

Below the magnetic part 10, the valve part 20 is linked. The valve part 20 is formed, among others, by the feed 21 arranged in the view shown here on the underside, the return 22, and the consumer connection 23 provided here between the feed 21 and the return 22.

A plurality of arrows a indicates the flow direction of the pressurized medium that is controlled or regulated by the control pressure valve. The medium enters the control pressure valve 1 in the feed 21 under pressure, and leaves it through the consumer connection 23 and/or the return 22.

The arrangement shown here is chosen such that the pressure control valve has (at least) two seat valves 30, 50.

The seat valve 30 arranged first in flow direction a of the medium in the feed 20 is formed here by an in particular loosely arranged valve element 31 (here a ball), that is pushed onto the seal seat 32 of the first seat valve 30 through the flow pressure of the medium. The valve element 31 shown here is configured, for example, as ball.

The valve element 51 in the second seat valve 50 is arranged stationary as sealing body on the activation rod 40, and interacts there, depending on the position of the activation rod, that depends on the position of the armature, with the seal seat 52 of the second seat valve.

In particular, the first seat valve 30 controls the pressure, and is arranged between the feed 21 and the consumer connection 23.

The second seat valve 50 is here in the direction a of the medium flow in a branch channel 53 after the first seat valve 30, and connects this branch channel 53 (when the second seat valve 50 is open) with the return 22.

It can be seen here clearly that the valve element 31 of the first seat valve 30 configured as ball is loose, and the front end 43 of the activation rod 40 acts on the valve element 31 from behind (with respect to the direction of medium flow). When the activation rod is operated accordingly (when the solenoid is flown through by current and the armature moves accordingly), the activation rod 40 can lift the valve element 31 at the seal seat 32 of the first seat valve.

The power to be applied here results from the medium pressure that is in connection with the return, and the passage surface of the first seat valve 30, that also has to be understood as aperture, aperture width, aperture opening 33 or as surface of the seat valve 31.

The effective volume flow that can flow through the first seat valve when the seat valve is open, is limited, on the one hand, by the diameter D of the seat valve 30 or seal seat 32 or aperture or aperture opening 33, and, on the other hand, by the diameter d of the front area 43 of the activation rod 40 projecting in the aperture 33, that acts on the valve element 31 (in the closed as well as in the opened valve/seat valve). An extreme widening of the aperture diameter D results in a corresponding increase of the opening forces, so that an enlargement of the volume flow by this is not possible without problems. The separated design of the activation rod 40 and the control rod 44, suggested according to the invention, offers the option of very filigree activation rods reducing the diameter of the activation rod accordingly. The same result is accomplished with the modification described alternatively, where a one-piece control-activation rod is provided, and the activation rod has a reduced diameter of less than 0.49 mm. The reduction of the dimensions of the disturbances in the aperture 33 results in an increase of the volume flow through the first seat valve 30.

Additionally, it has been found here that thus the ratio of the surface of the first seat valve 30 (the aperture of the first seat valve 30) and the cross section surface of the activation rod 40 can be enlarged considerably, and thus now is more than 4.5, in particular more than 5, preferably more than 6.

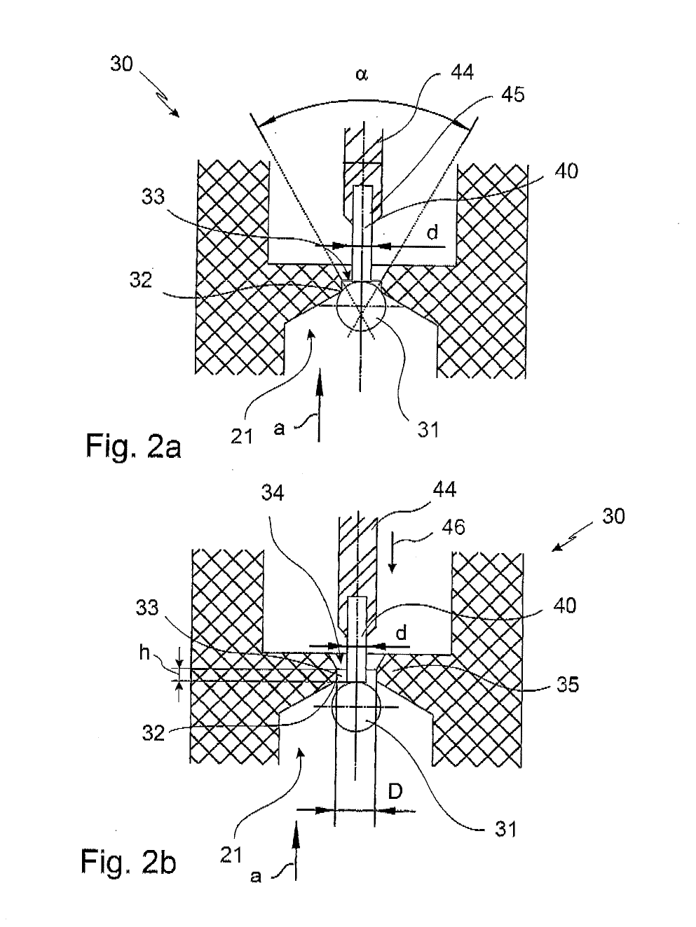

FIGS. 2a, 2b show in an enlarged lateral sectional representation the conditions in the first seat valve 30.

FIG. 2a shows the closed position of the seat valve 30, in FIG. 2b the control rod 44 has been shifted, for example because of the movement (see arrow 46) of the (not shown) armature such in direction of the aperture 33, that the activation rod 40 lifts the valve element 31, configured as ball, from the seal seat 32 of the (first) seat valve 30.

The seat valve 30 consists of the seal seat 32 and the valve element 31, that is supported, depending on the position of the activation rod 40, on the seal seat 32 and seals it (FIG. 2a) or is lifted and thus opens it (FIG. 2b).

The configuration of the seal seat 32 is determined by a feed 21 conically tapering in the end area in flow direction a, wherein at the seal seat 32 a cylindrical aperture 33 is provided the diameter of which corresponds with the diameter of the seal seat 32. Conveniently, the height h of this cylindrical aperture 33 is rather short or little to keep the flow resistance during the passage of the medium low. In flow direction a after the cylindrical (preferably circular) aperture 33 an in particular conical widening 34 is linked the opening angle a of which is in the range of 45° to 90°. The result of this widening 34 is that the material web 35 forming the aperture has a considerably larger thickness than the height h of the aperture 33. The material thickness is here in the area of the seat valve (that is the widening 34 and the aperture 33) about at least 1.5 times, preferably at least double, in particular preferred at least 2.5 or 3 times of the height h of the aperture 33. Such a configuration makes manufacturing of the filigree valve part 20, produced in a plastic injection process, considerably easier.

Furthermore, it can be seen in FIGS. 2a, 2b how the activation rod 40 is inserted in a front bore hole 45 of the control rod 44, and is fastened there appropriately.

The face of the activation rod 40 is a result of the surface product of the diameter d of the activation rod and the visible, that means projecting out of the control rod 44, length of the activation rod 40.

Although the invention has been described in terms of specific embodiments which are set forth in considerably detail, it should be understood that this is by way of illustration only and that the invention is not necessarily limited thereto, since alternative embodiments and operating techniques will become apparent to those skilled in the art in view of the disclosure. Accordingly, modifications are contemplated which can be made without departing from the spirit of the described invention.

1. Electro-magnetic pressure control valve with a magnetic part of at least one coil that can be electrically triggered, a coil core and an armature that is guided traversing and a valve part having at least one feed for the pressurised medium, at least one return and at least one consumer connection, wherein the valve part has at least two seat valves each of them being able to be closed by one seal seat each, wherein the valve elements are in active connection with the armature, and at the seat valve, first seen in direction of medium flow and having a surface, a loose valve element is provided that is adjustable by an activation rod against the pressure of the medium, and the activation rod is configured pin-like, has a diameter and a cross section surface, and is set in a control rod that is in active connection with the armature.

2. Pressure control valve according to claim 1, wherein in the seat valve, first seen in direction of medium flow, the diameter of the activation rod is less than 0.49 mm, in particular less than 0.45 mm, preferably less than 0.40 mm, has in particulate a diameter of less than 0.30 mm, preferably less than 0.25 mm.

3. Pressure control valve according to claim 1, wherein in the seat valve, first seen in direction of medium flow, the ratio of the surface of the seat valve or the seal seat of the seat valve to the cross section surface of the activation rod or a front end of the activation rod is more than 4.5, in particular more than 5, preferably more than 6, in particular preferred more than 7.

4. Pressure control valve according to claim 1, wherein in the seat valve, first seen in the direction of medium flow, the face of the activation rod is less than 1 mm², in particular less than 0.8 mm², preferably less than 0.7 mm².

5. Pressure control valve according to claim 1, wherein an aperture describing the first seat valve is provided, and wherein the activation rod projects in the aperture and the diameter is essentially constant, at least in this area.

6. Pressure control valve according to claim 1, wherein the valve element of the first seat valve is designed as loose ball, wherein the ball in the opened position of the seat valve is lifted from the seal seat by the activation rod against the flow of the medium.

7. Pressure control valve according to claim 1, wherein in the first seat valve on the side opposite the seal seat an in particular cone-like widening is provided, having preferably an opening angle a of 45° to 90°.

8. Pressure control valve according to claim 1, wherein in the first seat valve on the side opposite the seal seat an in particular cone-like widening is provided, having preferably an opening angle a of 45° to 90°, wherein between the seal seat and the widening a cylindrical aperture is provided, and the ratio of the height of the aperture to the diameter of the seal seat is less than 0.4, in particular less than 0.3.

9. Pressure control valve according to claim 1, wherein the pressure control valve is configured as proportional pressure control valve.

10. Pressure control valve according to claim 1, wherein the activation rod, in particular the tip of the activation rod facing the valve element consists of hardened material, preferably with a strength of more than 800 N/mm², in particular preferred more than 900 N/mm², or of a ceramic material.

11. Pressure control valve according to claim 1, wherein the control rod has on its front side facing the valve element a bore hole, wherein the bore hole shows the activation rod.

12. Pressure control valve according to claim 1, wherein a welding, solder and caulking or flanging connection is provided between the activation rod and the control rod.

13. Pressure control valve according to claim 1, wherein the operative connection between the armature and the valve element is formed by a one-piece unit or a unit stably connected of several elements of armature and control rod, or at least a power transmission between the otherwise single elements armature and control rod is provided.
